(19) United States
(12) Patent Application Publication
(10) Pub. No.: US 2026/0121422 A1
(43) Pub. Date: Apr. 30, 2026

(54) INTERACTION SELECTION METHOD FOR ELECTRIC VEHICLE CHARGING

(71) Applicant: Visa International Service Association, San Francisco, CA (US)

(72) Inventors: Christian Aabye, Redwood City, CA (US); Brian Sullivan, Buckinghamshire (GB)

(73) Assignee: Visa International Service Association, San Francisco, CA (US)

(21) Appl. No.: 19/165,546

(22) PCT Filed: Mar. 25, 2024
(86) PCT No.: PCT/US2024/021362

§ 371 Date: Sep. 15, 2025

Related U.S. Application Data
(60) Provisional application No. 63/492,468, filed on Mar. 27, 2023.

(51) Int. Cl. H02J 7/44; B60L 53/18; B60L 53/66

(52) U.S. Cl. CPC H02J 7/44; B60L 53/18; B60L 53/66

(57) ABSTRACT

A method is disclosed. The method includes receiving, by an electric vehicle, a list of available services associated with an electricity supply terminal. The list of available services includes one or more methods that do not transmit credentials or tokens via a charging cable and one or more methods that do transmit credentials or tokens via the charging cable. The method also includes determining, by the electric vehicle, a set of services in the list of available services. The set of services includes services supported by the electric vehicle. The method also includes transmitting, by the electric vehicle to the electricity supply terminal, a service selection request comprising a service in the set of services. The method also includes receiving, by the electric vehicle from the electricity supply terminal via the charging cable, electricity from the electricity supply terminal.

### CROSS-REFERENCES TO RELATED APPLICATIONS

This application is a PCT application which claims priority to and the benefit of U.S. Provisional Application No. 63/492,468, filed on Mar. 27, 2023, which is incorporated by reference in its entirety.

### BACKGROUND

Some methods use a credential or token to pay to charge an electric vehicle. The electric vehicle and an energy supply terminal can communicate with each other using a protocol such ISO-15118 and can automatically negotiate multiple charge session parameters, including how to pay for the charge session.

ISO 15118 relates an international standard defining a vehicle to grid (V2G) communication interface for bi-directional charging/discharging of electric vehicles. The standard provides multiple use cases like secure communication, smart charging and plug and charge features used by some electric vehicle networks.

Many existing electricity supply terminals have simple user interfaces. They cannot inform users as to all of the possible ways that they can interact with them. As a result, users may not be aware of certain services that can be used with electricity supply terminals when obtaining electricity from them.

Still further, when services involve methods that use credentials or tokens that are transmitted from electric vehicles to electricity supply terminals, they can be stolen by unauthorized users through hacking or skimming.

Embodiments of the invention can address these and other problems, individually and collectively.

### SUMMARY

One embodiment of the invention includes a method comprising: receiving, by an electric vehicle, a list of available services associated with an electricity supply terminal, the list of available services comprising one or more methods that do not transmit credentials or tokens via a charging cable and one or more methods that do transmit credentials or tokens via the charging cable; determining, by the electric vehicle, a set of services in the list of available services, wherein the set of services includes services supported by the electric vehicle; transmitting, by the electric vehicle to the electricity supply terminal, a service selection request comprising a service in the set of services; and after transmitting the service selection request, receiving, by the electric vehicle from the electricity supply terminal via the charging cable, electricity.

Another embodiment of the invention includes an electric vehicle comprising: a processor; and a non-transitory computer readable medium, the non-transitory computer readable medium comprising code, executable by the processor, for performing operations comprising: receiving a list of available services associated with an electricity supply terminal, the list of available services comprising one or more methods that do not transmit credentials or tokens via a charging cable and one or more methods that do transmit credentials or tokens via the charging cable; determining a set of services in the list of available services, wherein the set of services includes services supported by the electric vehicle; transmitting, to the electricity supply terminal, a service selection request comprising a service in the set of services; and after transmitting the service selection request, receiving, from the electricity supply terminal via the charging cable, electricity.

Another embodiment of the invention includes a method comprising: receiving, by an electricity supply terminal, a service selection request comprising a service in a set of services, after an electric an electric vehicle is provided with a list of available services associated with the electricity supply terminal, the list of available services comprising one or more methods that do not transmit credentials or tokens via a charging cable and one or more methods that do transmit credentials or tokens via the charging cable, wherein the electric vehicle determines the set of services in the list of available services, wherein the set of services includes services supported by the electric vehicle; and after receiving the service selection request, providing, to the electric vehicle from the electricity supply terminal via the charging cable, electricity.

Another embodiment of the invention includes an energy supply terminal comprising: a processor; and a non-transitory computer readable medium comprises code executable by the processor for performing operations comprising: receiving a service selection request comprising a service in a set of services, after an electric vehicle is provided with a list of available services associated with the electricity supply terminal, the list of available services comprising one or more methods that do not transmit credentials or tokens via a charging cable and one or more methods that do transmit credentials or tokens via the charging cable, wherein the electric vehicle determines the set of services in the list of available services, wherein the set of services includes services supported by the electric vehicle; and after receiving the service selection request, providing, to the electric vehicle via the charging cable, electricity.

A better understanding of the nature and advantages of embodiments of the invention may be gained with reference to the following detailed description and accompanying drawings.

### BRIEF DESCRIPTION OF THE DRAWINGS

FIG. 1 shows a block diagram of a system according to an embodiment.

FIG. 2 shows a block diagram of a vehicle according to an embodiment.

FIG. 3 shows a block diagram of supply terminal according to an embodiment.

FIG. 4 shows a block diagram of a service provider computer according to an embodiment.

FIG. 5 shows a block diagram of a user device according to an embodiment.

FIG. 6 shows a block diagram of a certificate distribution system according to an embodiment.

FIG. 7 shows a flowchart illustrating a method according to embodiments.

FIG. 8 shows a user interface according to some embodiments.

FIG. 9 shows a system diagram illustrating an electric vehicle and a supply terminal and interactions between them according to embodiments.

FIG. 10 shows a system diagram illustrating an electric vehicle, a supply terminal, and an operator computer and interactions between them according to embodiments.

FIG. 11 shows an interaction between a user device and a virtual access device in a vehicle in some embodiments.

FIG. 12 shows a flowchart illustrating a method for providing a list of available services to an electricity supply terminal.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be a device that is operated by a user. Examples of user devices may include a mobile phone, a smart phone, a card, a personal digital assistant (PDA), a laptop computer, a desktop computer, a server computer, a thin-client device, a tablet PC, etc. Additionally, user devices may be any type of wearable technology device, such as a watch, earpiece, rings, bracelets, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. A user device may also be a payment device such as a credit, debit, or prepaid card.

A “payment device” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. A payment device may be used to make a payment transaction. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc. Other examples of mobile communication devices include pagers, payment cards, security cards, access cards, smart media, transponders, and the like. If the payment device is in the form of a debit, credit, or smartcard, the payment device may also optionally have features such as magnetic stripes. Such devices can operate in either a contact or contactless mode. In some embodiments, a mobile communication device can function as a payment device (e.g., a mobile communication device can store and be able to transmit payment credentials for a transaction).

An “application” may be computer code or other data stored on a computer readable medium (e.g., memory element or secure element) that may be executable by a processor to complete a task.

A “key” may include a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “public key” may include an encryption key that may be shared openly and publicly. The public key may be designed to be shared and may be configured such that any information encrypted with the public key may only be decrypted using a private key associated with the public key (i.e., a public/private key pair).

A “private key” may include any encryption key that may be protected and secure. A private key may be securely stored at an entity and may be used to decrypt any information that has been encrypted with an associated public key of a public/private key pair associated with the private key.

A “public/private key pair” may refer to a pair of linked cryptographic keys generated by an entity. The public key may be used for public functions such as encrypting a message to send to the entity or for verifying a digital signature which was supposedly made by the entity. The private key, on the other hand may be used for private functions such as decrypting a received message or applying a digital signature. In some embodiments, the public key may be authorized by a body known as a Certification Authority (CA) which stores the public key in a database and distributes it to any other entity which requests it. The private key can typically be kept in a secure storage medium and will usually only be known to the entity. Public and private keys may be in any suitable format, including those based on Rivest-Shamir-Adleman (RSA) or elliptic curve cryptography (ECC).

A “digital signature” may include an electronic signature for a message. A digital signature may be a numeric data value, an alphanumeric data value, or any other type of data. In some embodiments, a digital signature may be a unique data value generated from a message (or data packet) and a private key using a cryptographic algorithm. In some embodiments, a validation algorithm using a public key may be used to verify the signature. A digital signature may be used to demonstrate the veracity of the sender.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to power delivery.

An “access device” may be any suitable device that provides access to a resource. An access device may be in any suitable form. Some examples of access devices include vending machines, kiosks, POS or point of sale devices (e.g., POS terminals), cellular phones, PDAs, personal computers (PCs), tablet PCS, hand-held specialized readers, set-top boxes, electronic cash registers (ECRs), automated teller machines (ATMs), virtual cash registers (VCRs), and the like. An access device may use any suitable contact or contactless mode of operation to send or receive data from, or associated with, a user mobile communication device. In some embodiments, an access device may include a reader, a processor, and a computer-readable medium. A reader may include any suitable contact or contactless mode of operation. For example, exemplary readers can include radio frequency (RF) antennas, optical scanners, bar code readers, or magnetic stripe readers to interact with a payment device and/or mobile communication device.

“Access data” may include any suitable data that can be used to access a resource or create data that can access a resource. In some embodiments, access data may be account information for a payment account. Account information may include a PAN, payment token, expiration date, card verification values (e.g., CVV, CVV2), dynamic card verification values (dCVV, dCVV2), an identifier of an issuer with which an account is held, etc. In other embodiments, access data could include data that can be used to access a location or to access secure data. Such information may be ticket information for an event, data to access a building, transit ticket information, passwords, biometrics or other credentials to access secure data, etc.

“Credentials” may comprise any evidence of authority, rights, or entitlement to privileges. For example, access credentials may comprise permissions to access certain tangible or intangible assets, such as a building or a file. Examples of credentials may include passwords, passcodes, or secret messages.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided to make a payment from a payment account. Payment credentials can also include a username, an expiration date, a gift card number or code, and any other suitable information.

A “digital signature” may include a type of electronic signature. A digital signature may encrypt documents with digital codes that can be difficult to duplicate. In some embodiments, a digital signature may refer to the result of applying an algorithm based on a public/private key pair, which allows a signing party to manifest, and a verifying party to verify, the authenticity and integrity of a document. The signing party acts by means of the private key and the verifying party acts by means of the public key. This process certifies the authenticity of the sender, the integrity of the signed document and the so-called principle of nonrepudiation, which does not allow disowning what has been signed. A certificate or other data that includes a digital signature by a signing party is said to be “signed” by the signing party.

A “certificate” or “digital certificate” may include an electronic document and/or data file. In some cases, the certificate or the digital certificate may be a device certificate. In some embodiments, a digital certificate may use a digital signature to bind a public key with data associated with an identity. A digital certificate may be used to prove the ownership of a public key. The certificate may include one or more data fields, such as the legal name of the identity, a serial number of the certificate, a valid-from and valid-to date for the certificate, certificate related permissions, etc. A certificate may contain a “valid-from” date indicating the first date the certificate is valid, and a “valid-to” date indicating the last date the certificate is valid. A certificate may also contain a hash of the data in the certificate including the data fields. A certificate can be signed by a certificate authority.

A “certificate authority” may include an entity that issues digital certificates. A certificate authority may prove its identity using a certificate authority certificate, which includes the certificate authority's public key. A certificate authority certificate may be signed by another certificate authority's private key or may be signed by the same certificate authority's private key. The latter is known as a self-signed certificate. The certificate authority may maintain a database of all certificates issued by the certificate authority. The certificate authority may maintain a list of revoked certificates. The certificate authority may be operated by an entity, for example, a processing network entity, an issuer, an acquirer, a central bank etc.

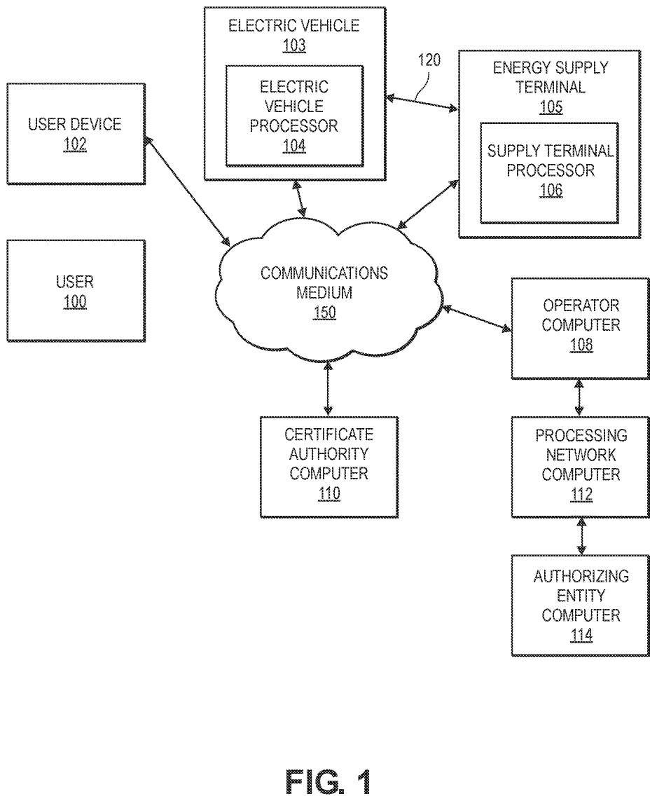

FIG. 1 shows a system according to embodiments. The system can comprise a user 100 that operates a user device 102 and an electric vehicle 103 comprising an electric vehicle processor 104 (which can be an example of a first processor). In some embodiments, the electric vehicle processor 104 can be an electric vehicle communication controller (EVCC).

The system can also include an energy supply terminal 105 (e.g., an electric vehicle charging station) comprising an energy supply terminal processor 106 (which can be an example of a second processor). In some embodiments, the energy supply terminal processor 106 can be a supply equipment communication controller (SECC).

The terms “electric vehicle communication controller (EVCC)” and “supply equipment communication controller (SECC)” are from ISO 15118. ISO 15118 is one of the International Electrotechnical Commission's (IEC) group of standards for electric road vehicles and electric industrial trucks. ISO 15118 is a proposed international standard defining a vehicle to grid (V2G) communication interface for bi-directional charging/discharging of electric vehicles.

A cable 120 can be attached to the energy supply terminal 105 and can physically and communicatively connect the electric vehicle and the energy supply terminal 105. In some embodiments, the cable 120 is an electric charging cable adapted to charge an electric car or other electric vehicle 103. In some embodiments, the energy supply terminal 105 and the electric vehicle 103 can communicate through a protocol such as ISO 15118.

In other embodiments, the cable 120 is not necessary where other energy supply mechanisms can be used. For example, the electric vehicle 103 can receive energy (e.g., electricity) from the energy supply terminal 105 via induction, which would not require the use of a physical charging cable. Communications passing between the energy supply terminal 105 and the electric vehicle 103 can occur via another wireless protocol such as Bluetooth™ or Wi-Fi™.

The system can further include a service provider computer 108 operated by a service provider and a certificate authority computer 110 operated by a certificate authority. The system may further include transaction processing subsystem which can include a processing network computer 112 in a processing network such as a payment processing network, and an authorizing entity computer 114, which may be in communication with the service provider computer 108. In some embodiments, an entity that operates the payment processing network can be referred to as a “mobility operator.”

The electrical components (e.g., the computers) in the system of FIG. 1 and any of the following figures can be in operative communication with each other through any suitable communications medium 150. Suitable examples of the communications medium 150 may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices of FIG. 1 may be transmitted using a secure communications protocol such as, but not limited to, File Transfer Protocol (FTP); HyperText Transfer Protocol (HTTP); WebSockets; and Secure Hypertext Transfer Protocol (HTTPS).

In some embodiments, the service provider operating the service provider computer 108 may be a service provider that can provide charging services to users. It may alternatively be an entity (e.g., a payment processor) that performs services on behalf of the service provider that provides charging services. Examples of the service providers can include charge point operators, electric vehicle manufacturers, payment processors such as payment service providers, etc.

In some embodiments, the user 100 may communicate with the service provider computer 108 to establish a service provider account if the user 110 has a preexisting relationship with the service provider. In some cases, the service provider account may be used to obtain electricity from the energy supply terminal 105. In some embodiments, the service provider account may be identified by a service provider account number such as eMobility account ID (eMAID). In other embodiments, the service provider operating the service provider computer 108 may not have a pre-existing relationship with the user 100.

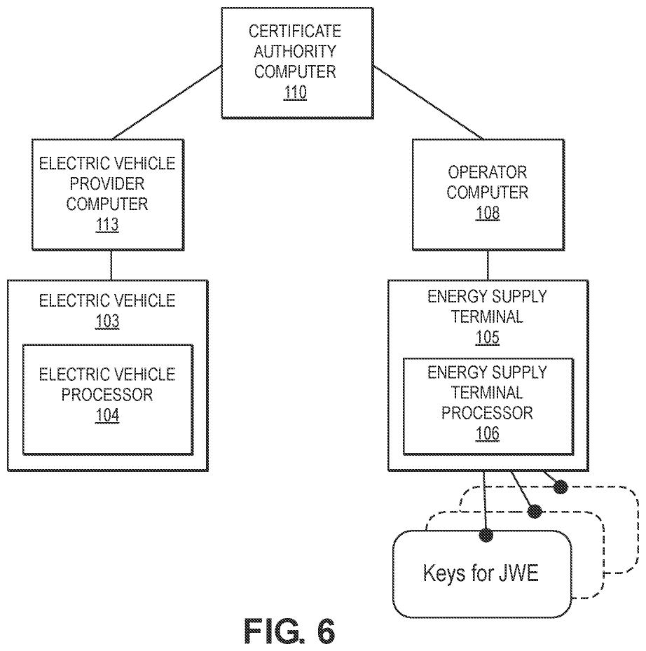

The certificate authority computer 110 may provide digital certificates to one or more of the other devices in FIG. 1. For example, the certificate authority computer 110 may provide sub-certificate authorities (e.g., mobility operators or other entities) with sub-root keys. The sub-certificate authorities can provide certificates to various entities. In some embodiments, a sub-certificate authority can issue a mobility operator electric vehicle digital certificate to an electric vehicle. Another sub-certificate authority can issue a mobility operator service provider digital certificate to a service provider operating a service provider computer. The mobility operator electric vehicle digital certificate and the mobility operator service provider digital certificate can originate from a mobility operator. An example of such a digital certificate system including a certificate authority computer is shown in FIG. 6.

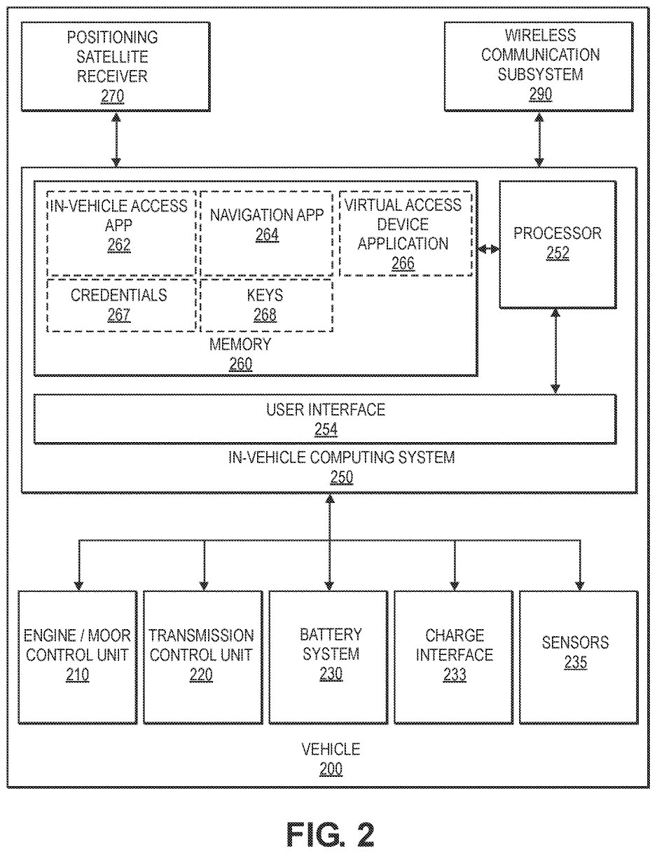

FIG. 2 illustrates a block diagram of a vehicle 200, according to some embodiments. Vehicle 200 can be, for example, an electric vehicle. Although vehicle 200 may be described as an automobile, it should be understood that in some embodiments, the techniques described herein can also be applied to other types of vehicles such as motorcycles, boats, aircrafts, or other types of powered machines that are used to transport a user from one location to another.

Vehicle 200 may include various electronic control units (ECUs) to operate and control the electrical system or other subsystems of vehicle 200, and may include sensors 235 that the ECUs can monitor. Each ECU may include a microcontroller and one or more memories (e.g., any combination of SRAM, EEPROM, Flash memories, etc.) to store one or more executable programs for the ECU. Examples of ECUs may include engine/motor control unit 210, transmission control unit 220, etc. In some embodiments, vehicle 200 may include additional ECU(s) not specifically shown, omit one or more ECUs, and/or integrate any of the functionalities of different ECUs into a single ECU. Additional sensors can include antennas such as NFC antennas or device readers, which can interact with external devices such as user devices.

Vehicle 200 can also include a battery system 230 comprising one or more batteries and a charge interface 233 for charging the one or more batteries. The battery system 230 and the charge interface 233 can be in communication with and coupled to the in-vehicle computing system 250 and its processor 252.

Engine/motor control unit 210 may control the actuators, valves, motor, and/or other components of the engine of vehicle 200, or an electric motor of the vehicle 200. Transmission control unit 220 may control the gear shifting and the transmission modes (e.g., park, drive, neutral, reverse) of vehicle 200. Battery system 230 may include electronics that can control the electrical voltage and current supplied by its one or more batteries to the various components of vehicle 200. Sensors 235 may include vehicle speed sensors (e.g., wheel sensors) to detect the speed of vehicle 200, temperature sensors to detect the operating temperature of the vehicle's various components, air sensors to detect oxygen level in the engine, sensors to detect the amount of energy currently (e.g., electricity, gas, etc.) present with the vehicle or the available capacity of any energy storage devices such batteries, cameras to observe the surroundings of vehicle 200, etc. The various ECUs, devices, and sensors may communicate with one another via a vehicle communication bus. Examples of vehicle communication bus may include a controller area network (CAN) bus, a local interconnect network (LIN) bus, a vehicle area network (VAN) bus, or other suitable signal buses for vehicle communication.

Vehicle 200 may also include various radio frequency (RF) transceivers to allow vehicle 200 to receive and transmit RF signals with other devices. For example, vehicle 200 may include a positioning satellite receiver 170 such as a GPS receiver to receive satellite signals that can be demodulated and decoded to determine the location of vehicle 200. The positioning satellite receiver 270 can be used by a positioning or navigation subsystem of vehicle 200 to perform routing and mapping functions.

Vehicle 200 may also include a wireless communication subsystem 290 to enable network connectivity for vehicle 200. Wireless communication subsystem 290 may include one or more wireless transceivers that use WiFi, WiMax, or other types of wireless network communication protocols to connect vehicle 200 to an external network (e.g., the Internet) such that vehicle 200 can communicate with remote servers. Wireless communication subsystem 290 may also include one or more short or near range wireless transceivers such as RFID, Bluetooth or Bluetooth Low Energy, NFC, beacon, infrared transmitters and/or receivers that can be used to communicate with an access device in proximity to vehicle 200.

Vehicle 200 may also include an in-vehicle computing system 250 with which a user of vehicle 200 can interact. In-vehicle computing system 250 can be an infosystem, infotainment system, or other instrumentation system. In-vehicle computing system 250 can be mounted in the center console, dashboard, rear console, or other locations in vehicle 200 that is convenient for a user to access in-vehicle computing system 250. In some embodiments, in-vehicle computing system 250 can be coupled to vehicle communication bus to receive vehicle status information from the ECUs and sensors 235.

In-vehicle computing system 250 may include a processor 252, a memory 260, and user interface 254. User interface 254 may include an input interface such as any number of buttons, knobs, microphone and/or a touchscreen that can receive user input, and an output interface such as a display (may be part of a touchscreen) and/or speakers. The display of user interface 254 can be integrated with the housing of in-vehicle computing system 250, or can be a separate component coupled to in-vehicle computing system 250 but mounted at a different location than in-vehicle computing system 250. For example, the display of user interface 254 can be mounted on the surface of the center console, on the dashboard, on the surface of the rear console, behind the headrest, on the interior ceiling, on the visor, or other suitable location in vehicle, and may display various types of information including information such as vehicle status information (e.g., speed, fuel economy, engine temperature, etc.), environmental information (e.g., inside/outside temperature, weather, etc.), navigation information (e.g., maps, routes, places of interests, etc.), entertainment such as videos or titles of audio selections or radio stations, energy level information (e.g., amount of charge present and needed to fill to capacity, amount of gas present and needed to fill to capacity), transaction information, energy terminal information, etc.

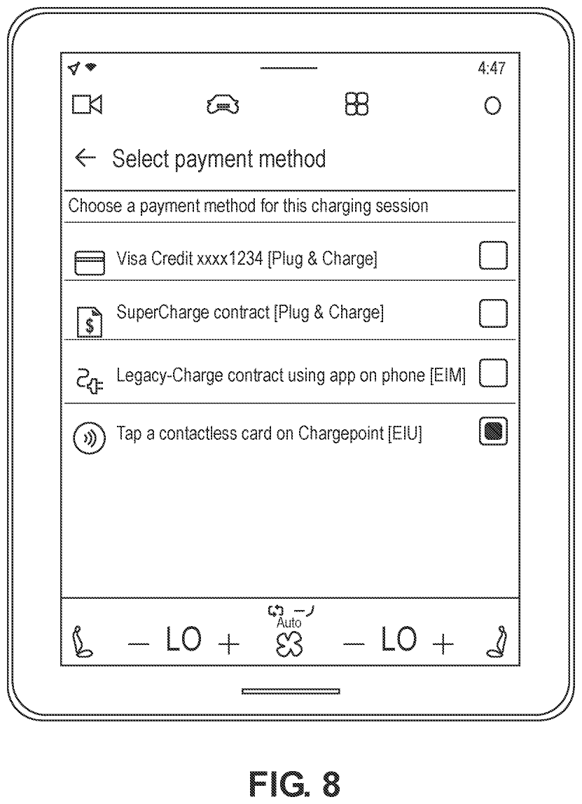

Memory 260 may include any combination of SRAM, DRAM, EEPROM, Flash, and/or other types of memories, etc. Memory 260 may store a number of applications such as in-vehicle access application 262, navigation application 264, a virtual access device application 266, and/or other applications not specifically shown such as a climate control application. The virtual access device application 266 can include code executable by the processor 252 to emulate an access device such as a point of sale terminal. Some functions programmed into the virtual access device application 266 are described below in the description of FIG. 8.

Navigation application 264 can be part of a positioning or navigation subsystem of vehicle 200, and may provide navigation functionalities such as mapping and routing functions. A user of vehicle 200 may input a desired location into in-vehicle computing system 250, and navigation application 264 can determine a current location of vehicle 200 using a positioning satellite receiver 270, and provide directions to travel to the desired location. Navigation application 264 may display a map on user interface 254 and highlight a route to a desired destination. Navigation application 264 may also display nearby places of interests and/or nearby merchants on user interface 254.

In-vehicle access application 262 enables in-vehicle computing system 250 to access resources for the vehicle 200. In some scenarios, in-vehicle access application 262 may allow a user of vehicle 200 to execute a transaction (e.g., a payment transaction) with a resource provider computer without requiring the user to exit vehicle 200, and without requiring the user to use another device such as the user's payment card or mobile device. In-vehicle access application 262 may store account credentials 267 or tokens, or reference identifiers thereof for various accounts, allow a user to select a particular account, and transmit the account credentials or tokens (or references identifiers thereof) associated with the selected account to a user device and/or server upon approval by the user. The memory 260 can also comprise cryptographic keys 268 can be used to encrypt data, sign data, verify data, etc.

The memory 260 can comprise a computer readable medium. The computer readable medium may comprise code, executable by the processor 252 to perform operations comprising: receiving a list of available services associated with an electricity supply terminal, the list of available services comprising one or more methods that do not transmit credentials or tokens via a charging cable and one or more methods that do transmit credentials or tokens via the charging cable; determining a set of services in the list of available services, wherein the set of services includes services supported by the electric vehicle; transmitting, to the electricity supply terminal, a service selection request comprising a service in the set of services; and
after transmitting the service selection request, receiving, from the electricity supply terminal via the charging cable, electricity.

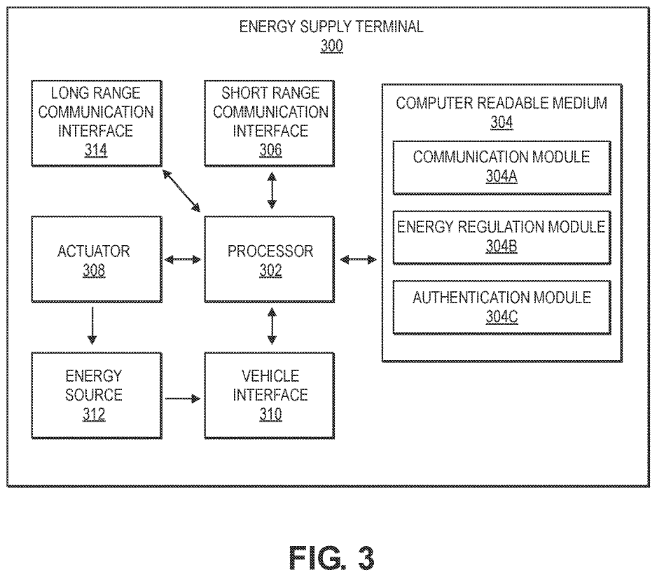

FIG. 3 shows a block diagram of an energy supply terminal 300 according to an embodiment. The energy supply terminal 300 can comprise a processor 302. The energy supply terminal may also comprise a computer readable medium 304, a short range communication interface 306, an actuator 308, a vehicle interface 310, and a long range communication interface 314 coupled to the processor 302. An energy source 312 can be coupled to the actuator 308 and the vehicle interface 310. The actuator 308 may be a switch (e.g., an electrical or mechanical switch) that allows the energy source 312 to provide energy to the vehicle interface 310 and then to a connected vehicle. The energy source 312 could be an electrical line or conduit, battery, capacitor, etc.

The computer readable medium 304 may further comprises a communication module 304A, an energy regulation module 304B, and an authentication module 304C. The communication module 304A can include code, executable by the processor 302 to allow the energy supply terminal 300 to communicate with external devices such as a vehicle or remote computer such as the previously described terminal support computer 70. The energy regulation module 304B and the processor 302 can determine how much energy is needed or should be provided to a vehicle, and can control the actuator 308 to control the flow of energy to the vehicle interface 310 and to the connected vehicle. The authentication module 304C can be used to authenticate a user and/or a vehicle that may be connected to the energy supply terminal 300.

The computer readable medium 304 may further comprise code, which when executed by the processor 302, causes the processor to perform operations comprising: receiving a service selection request comprising a service in a set of services, after an electric vehicle is provided with a list of available services associated with the electricity supply terminal, the list of available services comprising one or more methods that do not transmit credentials or tokens via a charging cable and one or more methods that do transmit credentials or tokens via the charging cable, wherein the electric vehicle determines the set of services in the list of available services, wherein the set of services includes services supported by the electric vehicle; and after receiving the service selection request, providing, to the electric vehicle via the charging cable, electricity.

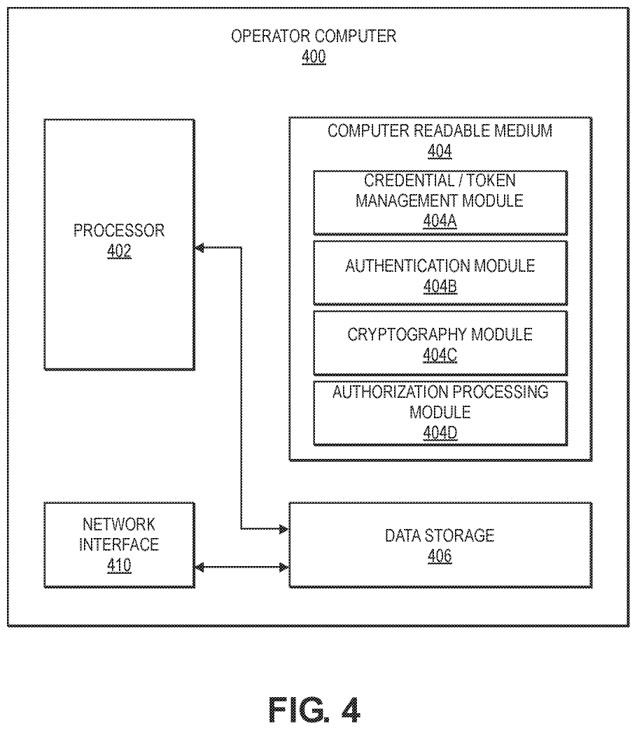

FIG. 4 shows a block diagram of service provider computer 400 according to an embodiment. The service provider computer 400 can comprise a processor 402, which may be coupled to a data storage 406 and a network interface 410. A computer readable medium 404 may also be operatively coupled to the processor 402. The data storage 406 can store any suitable data including but not limited to credentials and/or tokens, references to credentials and/or tokens, user data (e.g., usernames) or vehicle data (e.g., VINs) associated with the credentials or tokens, etc.

The computer readable medium 404 may comprise a number of software modules including a credential/token management module 404A, an authentication module 404B, and an authorization processing module 404D.

The credential/token management module 404A may comprise code that causes the processor 402 to retrieve credentials or tokens from the data storage 406 in response to receiving credential or token identifiers. The credential/token management module 404A may also comprise code that causes the processor 402 to receive and store credentials and/or tokens in the data storage 406.

The authentication module 404B may comprise code that causes the processor 402 to authenticate users, user devices, or vehicles used by users, before processing transactions.

The cryptography module 404C may comprise code that causes the processor 402 to perform cryptographic operations including encryption, decryption, hashing, signing, signature verification, key generation, etc.

The authorization processing module 404D may comprise code that causes the processor 402 to perform authorization processing. Authorization processing can include generating and transmitting authorization request messages or providing instructions to generate and transmit authorization request messages, receive authorization response messages, and generate notifications relating to transaction authorizations or declines. Authorizing processing can also including gathering data for an authorization and transmitting it to another computer.

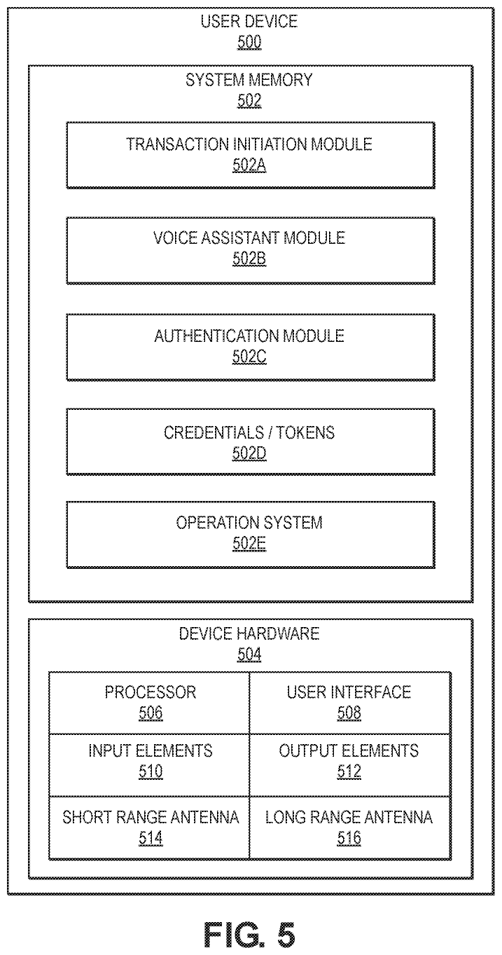

FIG. 5 shows a block diagram of a user device 500 in according to an embodiment. The user device 500 may include device hardware 504 coupled to a system memory 502.

Device hardware 504 may include a processor 506, a short range antenna 514, a long range antenna 516, input elements 510, a user interface 508, and output elements 512 (which may be part of the user interface 508). Examples of input elements may include microphones, keypads, touchscreens, sensors, etc. Examples of output elements may include speakers, display screens, and tactile devices.

The long range antenna 516 may include one or more RF transceivers and/or connectors that can be used by user device 500 to communicate with other devices and/or to connect with external networks. The user interface 508 can include any combination of input and output elements to allow a user to interact with and invoke the functionalities of user device 500. The short range antenna 509 may be configured to communicate with external entities through a short range communication medium (e.g., using Bluetooth, Wi-Fi, infrared, NFC, etc.). The long range antenna 819 may be configured to communicate with a remote base station and a remote cellular or data network, over the air.

The system memory 502 can be implemented using any combination of any number of non-volatile memories (e.g., flash memory) and volatile memories (e.g., DRAM, SRAM), or any other non-transitory storage medium, or a combination thereof media.

The system memory 502 may also store a transaction initiation module 502A, a voice assistant module 502B, an authentication module 502C, credentials and/or tokens 502D, and an operating system 502E, The transaction initiation module 502A may include instructions or code initiating and conducting a transaction with an external device such as an access device or a processing computer. It may include code, executable by the processor 506, for generating and transmitting authorization request messages, as well as receiving and forwarding authorization response messages. It may also include code, executable by the processor 506, for forming a local connection or otherwise interacting with an external device (e.g., an Operator computer). The voice assistant module 502B may comprise code, executable by the processor 506, to receive voice segments, and generate and analyze data corresponding to the voice segments. The authentication module 502C may comprise code, executable by the processor 506, to authenticate a user. This can be performed using user secrets (e.g., passwords) or user biometrics. System memory 502 may also store credentials and/or tokens or references to credentials and/or tokens 502D.

FIG. 6 shows a digital certificate structure according to embodiments. The certificate authority computer 110 operated by the certificate authority may store a root certificate. The root certificate may be a digital certificate associated with a root public key and a root private key. The certificate authority computer 110 may issue sub-root keys to a one or more sub-entities, which may include the organization that operates the certificate authority root, and/or third parties authorized by the certificate authority to operate as a sub-certificate authority.

FIG. 6 shows examples of sub-entity computers including a first sub-entity computer 113 operated by a first sub-entity (e.g., a service provider, a manufacturer, etc.) 113, and a second sub-entity computer 115 operated by a second sub-entity. For example, the certificate authority computer 110 may issue a first sub-root key pair to the first sub-entity computer 113 and can allow the first sub-entity operating the first sub-entity computer 113 to issue electric vehicle digital certificates (or “contract certificates” pursuant to ISO 15118) to electric vehicles. For example, the first sub-entity computer 113 may be operated by a mobility operator or a delegate of the mobility operator, and may issue a mobility operator electric vehicle digital certificate to the electric vehicle 103. The mobility operator electric vehicle digital certificate may comprise the electric vehicle public key, and the certificate or components thereof may be signed with a private key of the first sub-root key pair. An external entity may verify the mobility operator electric vehicle digital certificate by accessing the public key of the first sub-root key pair to validate the signed mobility operator electric vehicle digital certificate. The electric vehicle 103 may also be provisioned with the root certificate from the certificate authority computer 110. The root certificate can be used by an external entity to validate the first sub-entity computer 113 that issued the mobility operator electric vehicle digital certificate and that the mobility operator electric vehicle digital certificate is otherwise in good standing.

A similar process may be performed between the certificate authority computer 110 and the second sub-entity computer 115. In some embodiments, the second sub-entity computer 115 may be operated by a mobility operator or a delegate of the mobility operator. For example, the certificate authority computer 110 may issue a second sub-root key to the second sub-entity computer 115. The sub-entity computer may issue a mobility operator service provider digital certificate (e.g., a mobility operator payment service provider digital certificate) to a service provider that operates the energy supply terminal 105. The mobility operator service provider digital certificate may comprise a service provider public key. The mobility operator service provider digital certificate or components thereof may be signed with a private key of the second sub-root key pair. The mobility operator service provider digital certificates can be loaded into the energy supply terminals in the system. The energy supply terminals can be part of a charging network that work in conjunction with the service provider (e.g., charging network, a payment service provider, etc.). In some embodiments, the mobility operator service provider digital certificate can be transferred from the energy supply terminal 105 to the electric vehicle 103 during a charging session. The electric vehicle 103 uses the mobility operator service provider digital certificate (after authenticating with the certificate authority root, which will have been pre-installed) to generate session-unique keys that are used to create an encrypted package of data that can only be decrypted by the service provider to which the second sub-entity computer 115 had issued the mobility operator service provider certificate.

The certificate hierarchy illustrated in FIG. 6 can allow any electric vehicle to trust an energy supply terminal, and any energy supply terminal to trust any electric vehicle, since the certificates for those entities can correspond to the root public key and the root certificate of the certificate authority computer 110. For example, before the electric vehicle 103 transmits sensitive data (such as a credential or token) to the energy supply terminal 105, the electric vehicle processor 104 can receive the mobility operator service provider digital certificate of the energy supply terminal 105 and can validate digital signatures of both the second sub-entity computer 115 and the certificate authority computer 110.

Stated differently, the certificate hierarchy illustrated in FIG. 6 can allow any electric vehicle to trust an energy supply terminal, and any energy supply terminal to trust any electric vehicle, since the certificates for those entities can correspond to the root public key and the root certificate of the certificate authority computer 110. In accordance with ISO 15118, the electric vehicle certificates (left branch) can be used to sign messages originating from the electric vehicle 103 (which can be authenticated by the energy supply terminal 105 (which has the root certificate authority key of the certificate authority computer 110). In addition to the functionality described in ISO15118, the service provider certificate can be authenticated by the electric vehicle 103 (which has the root certificate authority key of the certificate authority computer 110), prior to creating the encrypted JWE that contains sensitive card data.

Some aspects pertaining to the certificate hierarchy and other aspects of embodiments can be found in WO 2023/192206, filed on Mar. 27, 2023, which is assigned to the same assignee as the present application, and is herein incorporated by reference in its entirety.

Some methods according to embodiments of the invention include specific ways to use a credential or token to pay to charge an electric vehicle. One feature of this type of method includes a user just plugging a charge cable into their electric vehicle, and then walking away. The electric vehicle and the energy supply terminal can communicate with each other using a protocol such as ISO-15118 protocol and can automatically negotiate multiple charge session parameters, including how to pay for the charge session.

An additional problem to be addressed is that the above approach may need to coexist with legacy methods of initiating charging sessions. A user may have an ISO 15118 capable EV (electric vehicle), and may have configured the EV with one or more 15118 payment methods, but may still want to pay for an individual session with a legacy method if one is available.

An energy supply terminal can conceivably support several methods of paying for charging. Examples of potential methods or services for paying for charging include the following:
i) A user can have a charge point operator (CPO) application on their user device, which is used to initiate charging. Typically, the user will have registered a payment instrument with the charge point operator, and the application will be used to unlock the charger and begin charging.
ii) An ISO 15118 type charging method, which includes the method described above, can be used. In this type of method, payment can occur using contract certificates provisioned into an electric vehicle.
iii) A user can pay by a contactless reader on the energy supply terminal (a contactless reader could be a proprietary RFID reader, or it could be an “EMV” (Europay, Mastercard, Visa) card reader).

Note that (i) is out of scope for ISO 15118; (ii) involves the use of ISO 15118; and (iii) can be accommodated under ISO 15118 as an “External Identification Means” (EIM). Alternatively, a contactless reader could be available on the energy supply terminal without being represented as an option at all in ISO 15118.

In general, none of the individual payment options (i.e., ISO 15118 or various legacy options) address the potential availability of other payment methods. Each considers other payment methods to be out of scope. The availability of multiple payment options at an energy supply terminal can be addressed in different ways. Additionally, many energy supply terminals do not have touch screens or physical buttons to enable choices to be made on the energy supply terminals. Embodiments of the invention can address this and other issues.

Embodiments of the invention propose to deal with this as part of ISO 15118 processing (which necessitates some minor changes to ISO 15118). Payment methods using ISO 15118 are new. Any electric vehicle or energy supply terminal operator will be incorporating new software and hardware. Legacy methods are old. It is harder to update the old software than to build additional functionality into new software.

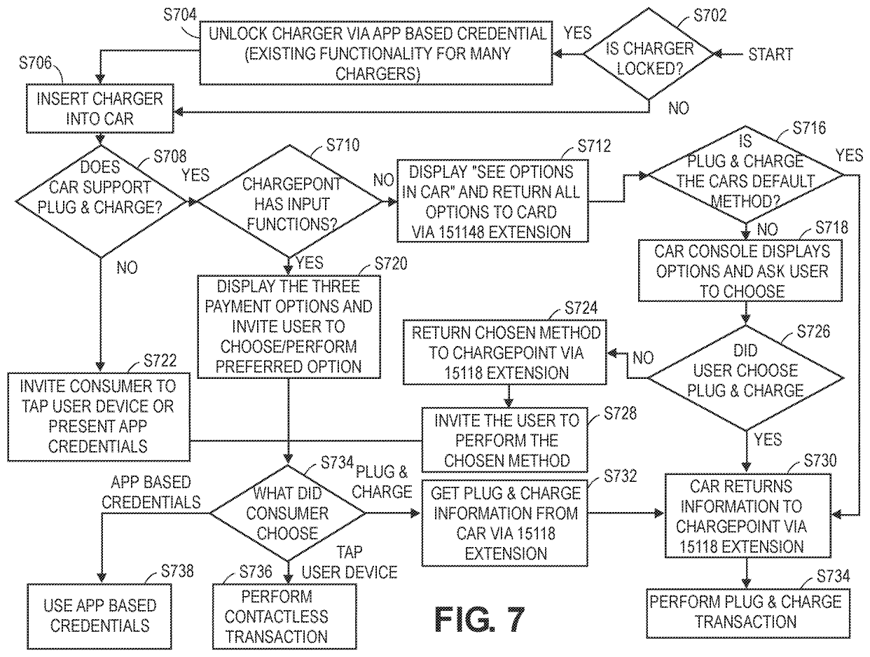

The flowchart illustrated in FIG. 7 shows process steps that can be used in embodiments of the invention. In the method illustrated in FIG. 7, an electric vehicle can approach an electricity supply terminal to receive a charge.

In step S702, the process starts by determining if the electricity supply terminal such as an electric charger of an electric supply terminal is locked.

If the charger is locked, then the user can use an application on their mobile phone to unlock the charger in step S704. Alternatively, the user can interact with a user interface on the charger to unlock it.

After step S704, or if the charger is not locked, then the user can insert the charger of the electricity supply terminal into their electric vehicle in step S706.

After the user has inserted the charger into their electric vehicle, then in step S708, the electric vehicle determines if the energy supply terminal supports an ISO 15118 type charging and communication session.

If the energy supply terminal does support an ISO 15118 type charging and communication session, then in step S710, the electric vehicle determines if the energy supply terminal has input functions.

If the energy supply terminal does have input functions, then at least three payment options can be presented to the user in step S720. In this example, the three payment options can include a first option including using a credential in a mobile application on a user device to pay, a second option including interacting directly with the electricity supply terminal to pay (e.g., by tapping a payment card against a reader in the energy supply terminal or inserting a payment card into the reader), and a third “plug and charge” option where a credential or token is received by the electricity supply terminal from the electric vehicle. The user can then choose a preferred option.

In step S734, a decision is made regarding the type of payment option that was chosen by the user.

In step S738, the user may have chosen to pay using a credential on a mobile application on a user device.

In step S736, the user may have chosen to pay using a contactless payment device at a card reader on the energy supply terminal.

In step S732, the user may have chosen to perform payment via an ISO 15118 type charging and communication session, where a credential or token is transmitted from the electric vehicle to the electricity supply terminal.

In steps S730 and S734, in the ISO 15118 type charging and communication session, the electric vehicle returns the payment information (e.g., encrypted payment information) to the energy supply terminal and the payment transaction is processed as described in further detail below.

Returning to step S708, if the electric vehicle does not support an ISO 15118 type charging and communication session, then in step S722, the user is invited to provide a payment device to the energy supply terminal or present credentials through their application as in conventional payment systems.

After step S722, in step S728, the user is invited to perform the payment using the chosen method.

Referring back to step S710, if the energy supply terminal does not have suitable input functions, then in step S712, a display in the electric vehicle can present a set of services to the user. All payment options or services can be returned via the ISO 15118 extension.

In step S716, the electric vehicle and the energy supply terminal can determine if the ISO 15118 extension payment and communication protocol is the default payment method.

If the ISO 15118 extension payment and communication protocol is the default payment method, then the method can proceed to steps S730 and S734.

If the ISO 15118 extension payment and communication protocol is not the default payment method, then in step S718, the electric vehicle console can display various payment options.

FIG. 8 shows a user interface according to some embodiments. The user interface shows a set of services including i) a plug and charge service that transmits a credential or token from the electrical vehicle to an electricity supply terminal via a charging cable to obtain electricity, ii) a plug and charge service that uses a charging contract identifier to obtain electricity, iii) a service that involves legacy charging contract that is associated with an application on a user's mobile phone, and iv) a service that allows a user to interact directly with the energy supply terminal.

In step S726, a decision can be made as to whether the ISO 15118 extension payment and communication protocol was chosen as the payment method.

If the answer to step S726 is “yes,” then the method can proceed to steps S730 and S734.

If the answer to step S726 is “no,” then the chosen method is returned to the electric supply terminal via the electrical cable via the ISO 15118 extension in step S724.

Then, in step S728, the user can be invited to perform the chosen payment method.

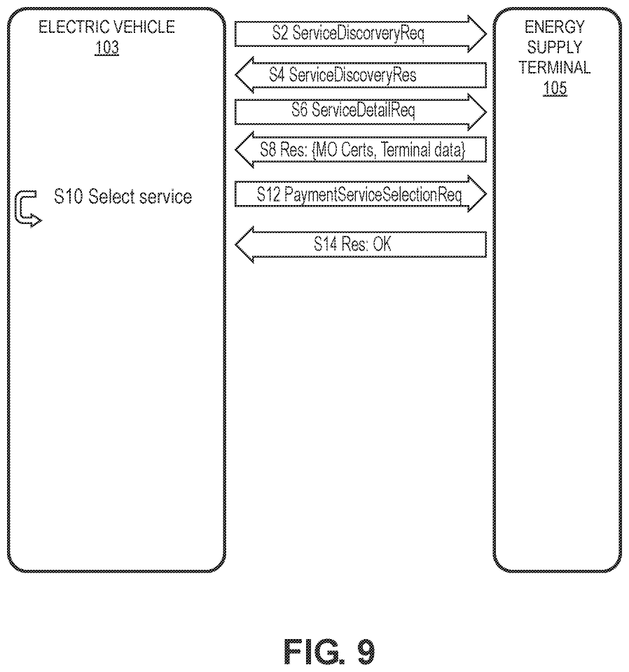

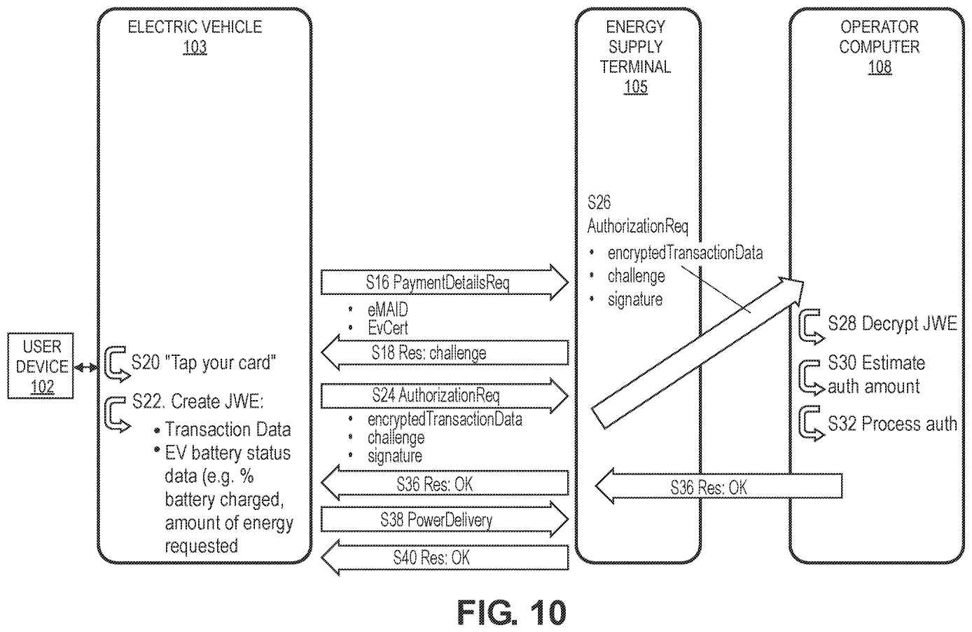

FIG. 9 shows a diagram and overlaid process flow according to embodiments for receiving a selection of a payment method. FIG. 10 shows a diagram and an overlaid process flow for perform a payment method where a credential or token is transmitted through a charging cable. The processes shown in FIG. 9 may be performed by the electric vehicle 103 and an energy supply terminal 105 (e.g., a charging station), and the processes shown in FIG. 10 can also include a service provider computer 108.

The user 100 can manipulate a charge cable attached to the energy supply terminal 105 and plug it into the electric vehicle 103. A communication session can then be established between the electric vehicle 103, which may comprise a first processor and the energy supply terminal 105, which may comprise a second processor via the charging cable. The charging cable is adapted to supply energy from the energy supply terminal 105 to the electric vehicle 103. The first processor in the electric vehicle 103 and the second processor in the energy supply terminal 105 can communicate using a protocol such as ISO 15118 (e.g., ISO 15118-2 or ISO 15118-20). The actions described below with respect to the electric vehicle 103 and the energy supply terminal 105 can be performed by the first processor, and the second processor, respectively.

At step S2, the electric vehicle 103 may transmit a service discovery request to the energy supply terminal 105. The service discovery request may request a list of services available at the energy supply terminal 105. The services can relate to specific methods for payment (e.g., interacting directly with an energy supply terminal, passing a credential or token through a charging cable, etc.) and/or specific payment instruments or accounts. Each service can be assigned a service name (e.g., “tap card at electricity supply terminal”) and a service identifier (e.g., “Xa102”).

In step S4, after receiving the service discovery request from the electric vehicle 103, the energy supply terminal 105 may transmit a service discovery response comprising a list of available services to the electric vehicle 103. For example, the energy supply terminal 105 may indicate that that the list of services illustrated in FIG. 8 are available.

At step S6, after receiving the service discovery response from the energy supply terminal 105, the electric vehicle 103 may determine a set of services from the list of available services that it supports. After the electric vehicle 103 determines the set of services that is supports, the electric vehicle 103 can then transmit a service detail request to the energy supply terminal 105. The service detail request may request details associated with one or more services that are compatible with the electric vehicle 103. In some embodiments, the service detail request may comprise indicators for the one or more compatible services.

In step S8, after receiving the service detail request from the electric vehicle 103, the energy supply terminal 105 may transmit a service detail response to the electric vehicle 103. The service detail response can comprise energy supply terminal data (e.g., a terminal identifier) and a mobility operator service provider digital certificate associated with the service provider computer 108 and issued by a mobility operator (e.g., such as the above described certificate authority, or sub-authority). The mobility operator service provider digital certificate can comprise a public key associated with private key stored at the service provider computer 108 that services a charging network including the energy supply terminal 105. The mobility operator service provider digital certificate can also include other data such as the data described above under the term “digital certificate” including the name of the service provider, an issuance date, an expiration date, and a digital signature. The electric vehicle 103 can also validate the mobility operator service provider digital certificate by verifying the certificate chain to the certificate authority root, and by determining if it is not expired.

Stated differently, the electric vehicle 103 will have an integrity-checked copy of the certificate authority root certificate that was previously installed (this could happen during manufacturing, or some point after manufacturing). As described above, the electric vehicle 103 will receive a mobility operator service provider digital certificate in the service detail response. If a sub-certificate authority has been used, then the mobility operator service provider digital certificate will comprise a service provider leaf certificate and a sub-certificate authority certificate. If a sub-certificate authority has not been used, then the mobility operator service provider digital certificate will just contain the service provider leaf certificate. The electric vehicle 103 can verify the certificate chain of the service provider certificate. For example, if a sub-certificate authority ID is present, then the electric vehicle 103 can authenticate the service provider leaf certificate with the sub-certificate authority, and then the electric vehicle 103 can authenticate the sub-certificate authority certificate with the certificate authority root. If there is no sub-certificate authority certificate, then the electric vehicle 103 can authenticate the service provider leaf certificate directly with the sub-certificate authority.

In step S10, the electric vehicle 103 may prompt the user to select one or more services (e.g., via a display on the electric vehicle 103, via the user device 102, etc.) from the set of services that are compatible with both the electric vehicle 103 and the energy supply terminal 105.

FIG. 8 shows a user interface according to some embodiments. The user interface shows a set of services including 1) a plug and charge service that transmits a credential or token from the electrical vehicle to an electricity supply terminal via a charging cable to obtain electricity (this process is described in further detail below with respect to FIGS. 10), 2) a plug and charge service that uses a charging contract identifier to obtain electricity (this is an ISO 15118 plug & charge contract), 3) a service that involves legacy charging contract that is associated with an application on a user's mobile phone (this is the legacy app (non-15118). From an ISO 15118 perspective, this is an EIM), and 4) a service that allows a user to interact directly with the energy supply terminal (e.g., “tap a contactless card on energy supply terminal (EIM)”).

Options 1 and 2 above are ISO 15118 plug and charge options. The electric vehicle identifies these as payment options using standard ISO 15118 and “plug and go” processing. Options 3 and 4 above are non-plug and charge options. As far as ISO 15118 is concerned, these 2 options would be classed as “External Identification Means”. In the example above, the options 3 and 4 are presented to the user based on the descriptive strings received by the electric vehicle. Note that the options in FIG. 8 are not limiting, and other options for different services such as different payment cards (e.g., Visa, Mastercard, Discover, etc.) can be displayed.

The user may select from one of the options shown in FIG. 8. Alternatively, this selection could be performed automatically by the electric vehicle 103 based on pre-established consumer preferences.

In step S12, after receiving the service detail response from the energy supply terminal 105, the electric vehicle 103 may transmit an interaction service selection request comprising the selected service(s) to the energy supply terminal 105. In some embodiments, the selected service can be a particular payment service application. For example, the electric vehicle can send a payment service selection request message: PAYMENTSERVICESELECTIONREQ containing the following data elements:
SelectedPaymentOption=EIM
ServiceList=includes the Serviceld for one of the one of the “non-ISO 15118 EIM” options.

In step S14, after receiving the interaction service selection request from the electric vehicle 103, the energy supply terminal 105 may transmit an interaction service selection response to the electric vehicle 103. The interaction service selection response may verify the service selection.

If the process that is selected includes the transmission of a credential or token through the electric charging cable, then the process flow in FIG. 10 can be performed.

At step S16, after receiving the interaction service selection response from the energy supply terminal 105, the electric vehicle 103 may transmit an interaction details request comprising a mobility operator electric vehicle digital certificate to the energy supply terminal 105. In some cases, a contract identifier such as an eMAID may also be present in the interaction details request. The eMAID can identify a contract that is associated with the electric vehicle 103 to the energy supply terminal 105. In some cases, the contract identifier can cause the energy supply terminal 105 to provide specific services to the user of the electric vehicle 103 as a result of the transaction (e.g., rewards, data collection, etc.).

At step S18, after receiving the interaction details request from the electric vehicle 103, the energy supply terminal 105 may verify the mobility operator electric vehicle digital certificate to determine that it is valid. For example, the energy supply terminal 105 can validate the signatures of a certificate authority computer and any sub-certificate authority computer using the appropriate public keys and may also verify that the certificate is not expired. If the energy supply terminal 105 determines that the mobility operator electric vehicle digital certificate is valid, then it can transmit an interaction details response comprising a challenge to the electric vehicle 103. In some embodiments, the challenge may be a string of random numbers. The electric vehicle 103 may thereafter form a signed challenge by signing the challenge using a private key associated with a public key in the mobility operator electric vehicle digital certificate.

At step S20, before or after signing the challenge to form a signed challenge, the electric vehicle 103 may provide an interaction data request to the user operating the user device 102. The interaction data request may prompt the user (e.g., via a user interface in the electric vehicle 103 or through a mobile phone of the user) to interact the user device 102 with a reader on the electric vehicle 103, so that the electric vehicle 103 can obtain a credential or token from the user device 102. For example, the user device 102 may be a credit card, and a reader in the electric vehicle 103 may be a contact or contactless card reader (e.g., an NFC reader). The reader in the electric vehicle 103 can read the credential or token from a memory in the user device 102.

In other embodiments, the user need not interact the user device 102 with the electric vehicle 103. The credential or the token can be stored in a memory (such as a secure element) in the electric vehicle 103 and can be obtained from the memory.

In other embodiments, the user may choose a payment credential or token on their mobile phone which may be attached to the electric vehicle 103 using Bluetooth, Wi-Fi or a physical cable. In this case, the credential or token could be obtained from the memory of the mobile phone, or may be retrieved by the phone from some Internet based service which may be identified using configuration data received from the energy supply terminal 105 in S8.

In some embodiments, in response to receiving the interaction details request, the electric vehicle 103 can determine an amount of charge needed to fill the battery in the electric vehicle 103 with electricity. For example, the electric vehicle 103 can determine the amount of battery capacity that is available in the battery of the electric vehicle 103 and can determine the amount of electricity needed to fill it.

At step S22, the electric vehicle 103 can generate an encrypted data packet by encrypting interaction data including at least the credential or token, and (optionally) the amount of electricity needed to fully charge the battery of the electric vehicle 103, with a session key derived using an algorithm such as Elliptic Curve-Diffie Hellman, with the service provider public key obtained from the mobility operator service provider digital certificate. Prior to doing so, the electric vehicle 103 can verify that the mobility operator service provider digital certificate is valid and authentic. In some embodiments, JWE (JSON Web Encryption) can be used. Then, an authorization request message comprising the encrypted data packet, the challenge, and the signed challenge may be generated by the electric vehicle 103 and then transmitted to the energy supply terminal 105 in step S24. The message that is used to transmit the encrypted data packet, the challenge received in S18, and the signed challenge can be in a data format compatible with ISO 15118.

At step S26, after receiving the authorization request message from the electric vehicle 103, the energy supply terminal 105 may verify the signed challenge using the public key in the mobility operator electric vehicle digital certificate. Once the signed challenge is verified, the energy supply terminal 105 can transmit the authorization request message to the service provider computer 108. In other embodiments, the signed challenge could be verified by the service provider computer 108 instead of the energy supply terminal 105.

At step S28, the service provider computer 108 can decrypt the encrypted interaction data using a session key derived using an algorithm such as Elliptic Curve-Diffie Hellman with the private key of the service provider computer 108 and the data supplied with the JWE created by the electric vehicle 103 to obtain the credential or token, and the amount of electricity needed to fully charge the battery of the electric vehicle 103. The service provider computer 108 can then process a transaction for supplying the electric vehicle with electricity using at least the credential or the token.

In step S30, the service provider computer 108 can estimate an amount of the transaction using the amount of electricity in the authorization request message. In some embodiments, the service provider computer 108 can store a conversion table which correlates amounts of electricity with various costs, or it can store a conversion factor which allows the service provider computer 108 to calculate a cost based upon an amount of electricity. In other embodiments, the amount of the transaction can simply be a fixed cost, which would cover fully charging any vehicle battery from empty.

More specifically, in some embodiments, if the amount of the electrical charge obtained by the user is not yet known when the user provides an account number to the energy supply terminal 105, the service provider computer 108 may then determine a pre-authorization amount (e.g., an amount of funds to be reserved for payment of charging the electric vehicle 103). The service provider computer 108 may determine the pre-authorization amount after receiving and determining the information regarding the percent battery charge amount requested or needed to fully charge the battery in the electric vehicle 103. For example, the current cost per kilowatt hour can be multiplied by the amount of estimated charged needed to determine the pre-authorization amount. For instance, the service provider computer 108 may determine that the pre-authorization amount is $20.00, since the battery in the electric vehicle is 50% full and has 50% capacity to charge. The pre-authorization amount may be included with a token or credential in an authorization request message. The service provider computer 108 may then process the authorization request message, which may include communicating with a payment processing network to authorize a payment. After the authorization request is processed, the service provider computer 108 may transmit an authorization response to the energy supply terminal 105 (e.g., which indicates if the interaction is authorized or is not authorized). The amount of the authorization request is then held in the user's account. After the charging of the electric vehicle 103 is completed, the cost of the charge is later determined by the service provider computer 108 and a subsequent message (e.g., another authorization or clearing message) may be sent to the authorizing entity computer with the actual cost of the charge, and the previous hold may be released. For example, if $20 was held and the actual cost of the charge was $10, then the hold on the remaining $10 is released.

In other embodiments, if the amount of electrical charge is known, then the transaction amount for that charge is included in an authorization request message with the credential or token.

The authorization request message generated by the service provider computer 108 may also be converted to a different data format (e.g., from ISO 15118 or XML type data format to ISO 8583). The service provider computer 108 may then process the authorization request message, which may include communicating with a processing network computer 112 and an authorizing entity computer 114 to authorize a payment. After the authorization request is processed, the service provider computer 108 may receive an authorization response indicating whether or not the transaction is authorized from the processing network computer 112 and the authorizing entity computer 114.

In step S32, the service provider computer 108 can transmit the authorization request message to an authorizing entity computer 114 operated by an issuer (e.g., via a transport computer operated by an acquirer and a processing network computer 112 operated by a payment processing network) of an account associated with the credential or the token. The authorization request message may be converted to a different data format such as an ISO 8583 type data format. The authorizing entity computer 114 can authorize or decline the transaction and can transmit an authorization response message with the authorization decision back to the service provider computer 108.

If the authorization request message comprises a token, instead of a credential such as a PAN, the processing network computer 112 can detokenize the token into a real PAN and can replace the token with the real PAN before transmitting the authorization request message to the authorizing entity computer 114.

In step S34, after receiving the authorization response message, the service provider computer 108 and provide the authorization response message or may provide an authorization respond message in a different data format back to the energy supply terminal 105. The authorization response message may then be transmitted to the electric vehicle 103 in step S36.

At step S38, after receiving the authorization response from the energy supply terminal 105, the electric vehicle 103 may transmit a power delivery request to the energy supply terminal 105. The power delivery request may be a request to charge the electric vehicle 103.

In step S40, after receiving the power delivery request from the electric vehicle 103, the energy supply terminal 105 may transmit a power delivery response to the electric vehicle 103. After receiving the power delivery response from the energy supply terminal 105, the electric vehicle 103 may receive power from the energy supply terminal 105.

In some embodiments, a clearing and settlement process can be performed between a payment processing network, an acquirer of the service provider computer, and an issuer of the credential after the electric vehicle has been charged.

If the authorization request message to the authorizing entity computer was a pre-authorization request message, then the actual cost of the amount of electricity obtained by the electric vehicle 103 can be included in a subsequent authorization request with the actual amount can be submitted by the service provider computer 108 and any hold on the user's account as a result of the pre-authorization request message processing can be released.

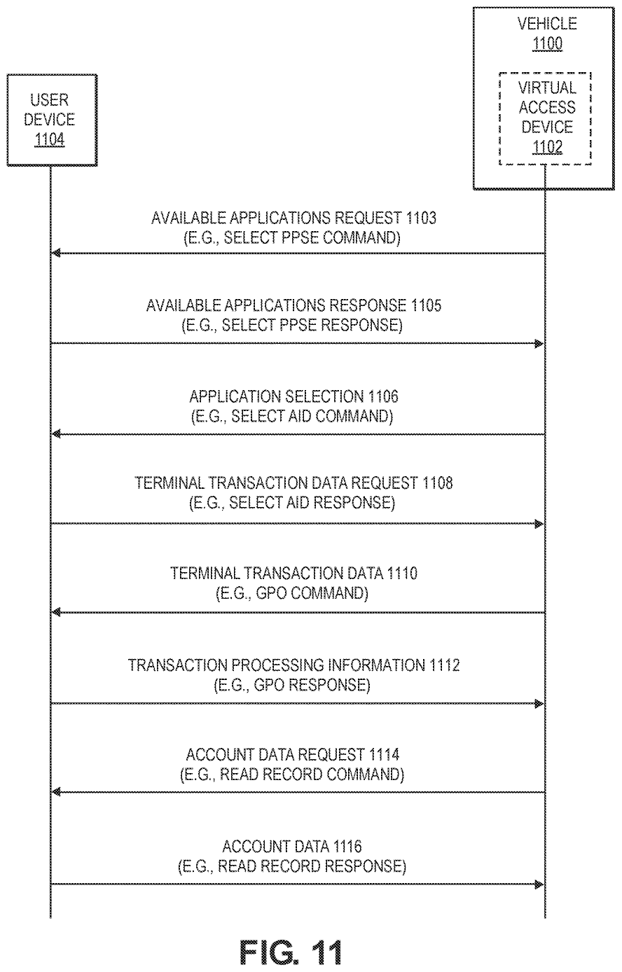

FIG. 11 illustrates an example communication flow between a user device 1104 and a virtual access device 1102 on a vehicle 1100 according to some embodiments. The steps in FIG. 11 can occur in step S20 in the flow described above with respect to FIG. 10. User device 1104 can be a payment card, a mobile phone, a secure element in the electric vehicle 103, etc.

Virtual access device 1102 can be emulated, for example, based on an access device profile obtained from an actual access device such as an actual point of sale (POS) terminal. The communications can be in the form of application commands sent from virtual access device 1102 and application data responses sent from user device 1104 in response to the application commands. In some embodiments, the application commands and data responses can be in the form of APDU commands and responses. However, it should be understood that other messages, messaging protocols, or formats can be used to exchange the application data to conduct the transaction.

To initiate the application data exchange, virtual access device 1102 may initiate a transaction by sending an available applications request 1103 to user device 1104 to request information as to which payment application identifier(s) (AID(s)) may be available. Each AID may correspond to an account of the user and/or processing options associated with an account. In some embodiments, the available application(s) request 1103 may be in the form of a select PPSE command. The available applications request 1103 may include a payment environment identifier (e.g., a PPSE name) to identify the payment environment supported by virtual access device 1102.

Upon receiving the available applications request 1103, user device 1104 may identify and process the request by recognizing the payment environment identifier (e.g., PPSE name) included in the request, and respond by sending an available applications response 1105 back to virtual access device 1102. The available applications response 1105 may include a list of available AIDs, and may include the payment environment identifier (e.g., PPSE name) as the dedicated file name. In some embodiments, the available applications response 1105 may be in the form of a select PPSE response and may include PPSE file control information (FCI). For example, the available applications response 1105 may include a directory entry for each available AID. If user device 1104 supports only one AID, user device 1104 may respond with a single directory entry for the supported AID. If user device 1104 supports an account with multiple AIDs, the transaction application may respond with a directory entry for each of the supported AIDs. Each directory entry may include information such as the AID, an application label associated with the AID (e.g., a mnemonic associated with the AID), an application priority indicator indicating the priority of the AID, a kernel identifier indicating the application's kernel preference, and/or additional information relating to the particular AID. The available application(s) response 1104 may also include other data such as FCI issuer discretionary data.

When virtual access device 1102 receives the available applications response 1105, virtual access device 1102 may select a suitable application from the list of applications received in the available applications response 1105 (e.g., by selecting an AID from the available AID(s) received in the available application(s) response 1105). In some embodiments, the selected AID can be the highest priority AID on a prioritized list of application identifiers supported by the access device being emulated by virtual access device 1102. The prioritized list of application identifiers can be obtained as part of the access device profile. Virtual access device 1102 may send an application selection 1106 with the selected AID to user device 1104 to continue the transaction. In some embodiments, the application selection 1106 can be in the form of a select AID command.

Upon receiving the application selection 1106, user device 1104 may send a terminal transaction data request 1108 to request transaction data from virtual access device 1102 to execute the transaction using the selected application/AID. In some embodiments, the terminal transaction data request 1108 may be in the form of a select AID response and may include AID file control information (FCI) with the selected AID as the dedicated file name. The terminal transaction data request 1108 may include a list of transaction data identifiers to request the appropriate data from virtual access device 1102, and the list of transaction data identifiers can be in the form of a processing options data object list (PDOL). The transaction data requested by user device 1104 for the transaction may include terminal transaction qualifiers (TTQ), authorized amount, other amount, terminal country code, terminal verification results, transaction currency code, transaction data, transaction type, and/or an unpredictable number. The terminal transaction data request 1108 may also include other data such as FCI issuer discretionary data, application program identifier, and language preference.

After receiving the terminal transaction data request 1108, virtual access device 1102 may send to user device 1104, the terminal transaction data 1110 requested by user device 1104. The terminal transaction data 1110 provided by virtual access device 1102 can be obtained from the access device profile. In some embodiments, the terminal transaction data 1110 may be sent in the form of a get processing options (GPO) command, and may include the requested terminal transaction data in a processing options data object list (PDOL). In some embodiments, the terminal transaction data 1110 (e.g., terminal transaction qualifiers (TTQ)) may include a transaction type indicator indicating the type of transaction supported by the access device. In some embodiments, the terminal transaction data 1110 (e.g., terminal transaction qualifiers (TTQ)) may also include a consumer verification method (CVM) requirement indicator to indicate whether a CVM is required by the access device for the transaction, and also one or more CVM type indicators indicating the types of CVM supported by the access device. Examples of CVMs that may be supported by the access device can include online PIN, signature, and/or consumer device CVM (CDCVM) such as a passcode to unlock the screen or user device 1104.

Once the user device 1104 receives terminal transaction data 1110, user device 1104 may increment its Application Transaction Counter (ATC), generate dynamic transaction processing information using at least some of the received terminal transaction data 1110, and send a set of transaction processing information 1112 including the generated dynamic transaction processing information to virtual access device 1102. In some embodiments, the transaction processing information 1112 can be sent in the form of a GPO response. In some embodiments, the transaction processing information 1112 may include one or more application file locators (AFLs) that can be used as file address(es) by virtual access device 1102 to read account data stored on user device 1104, and an application interchange profile (AIP) that can be used to indicate the capabilities of user device 1104.

In some embodiments, the AFLs included in transaction processing information 1112 may include file addresses to read account data such as a transaction cryptogram dynamically generated using a limited-use key (LUK) and/or unpredictable number from the access device, track-2 equivalent data including a token or a PAN, and addition data such as issuer application data (IAD), form factor indicator (FFI), card transaction qualifiers (CTQ), cryptogram information data (CID), the updated ATC, and/or an application PAN sequence number (PSN). In some embodiments, the issuer application data (IAD) may include a length indicator indicating the length of the IAD, cryptogram version number (CVN) indicating the version of the transaction cryptogram, a derived key indicator (DKI) that can be used to identify a master key (e.g. a master key associated with the issuer used in generation of the LUK), card verification results (CVR), a wallet provider ID, and/or derivation data such as the key index that was used in the generation of the LUK. In some embodiments, transaction processing information 1112 may include the above account data themselves instead of their corresponding AFLs, or a combination thereof. It should also be understood that in some embodiments, the transaction processing information 1112 being sent from user device 1104 to virtual access device 1102 may include some or all of the information describe above, and in some embodiments, may include additional information not specifically described.

After virtual access device 1102 receives the transaction processing information 1112, virtual access device 1102 may send an account data request 1114 to user device 1104 to read additional account data that may be stored on the user device 1104. In some embodiments, the account data request 1114 may be in the form of a read record command, and may include an application file locator (AFL) indicating the location of the account data that virtual access device 1102 is attempting to read. The AFL included in the account data request 1114 may correspond to an AFL in the transaction processing information 1112 that was provided to virtual access device 1102 from user device 1104.

In response to receiving the account data request 1114 from virtual access device 1102, user device 1104 may send the account data 1116 stored at the location indicated by the AFL to virtual access device 1102. In some embodiments, the account data 1116 may be sent in the form of a read record response. The account data 1116 may include, for example, the account data elements discussed above (e.g., a PAN, token, CVV, etc.), and/or application usage control that indicates the issuer's restrictions on the usage and services allowed for the application, the cardholder's name, customer exclusive data, issuer country code, token requester ID (e.g., if a token is used), and/or other account related data that is accessible at the AFL location. It should be understood that in some embodiments, the account data 1116 being sent from user device 1104 to virtual access device 1102 may include some or all of the information described above, and in some embodiments, may include additional information not specifically described.

In some embodiments, there can be more than one pair of account data request 1114 and account data 1116 communication exchanges between virtual access device 1102 and user device 1104. Once virtual access device 1102 has received the requisite data from the transaction processing information 1112 and/or one or more account data 1116 transmissions, some or all of the data elements in the transaction processing information 1112 and/or one or more account data 1116 transmissions can be concatenated by virtual access device 1102 to form a data packet. The data packet may include a checksum and a packet length indicator to indicate the length of the data packet. The data packet can be used by the virtual access device to generate a transaction authorization request message to request authorization of the transaction from the issuer. For example, in some embodiments, the transaction authorization request message may include at least the track-2 equivalent data including a token or PAN, and the transaction cryptogram generated with the LUK, and the transaction can be authorized based on at least verifying that the transaction cryptogram was generated correctly and that the LUK used in generation of the transaction cryptogram has not exhausted the LUK's set of one or more limited use thresholds.

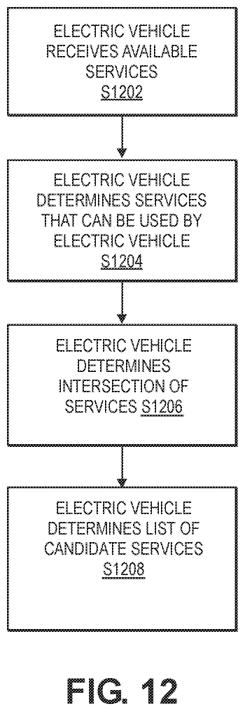

In the embodiments described above with respect to FIG. 9, the list of available services associated with an electricity supply terminal is provided by the electricity supply terminal to an electric vehicle via a charging cable. In other embodiments, the list of available services can be provided over-the-air to the electric vehicle. It can be provided to the electric vehicle by a remote computer (e.g., service provider computer 108 in FIG. 1) such as a remote server in communication or not in communication with the electric supply terminal. In some cases, the list of available services for electricity supply terminals within a predetermined distance of the electric vehicle (e.g., 2 miles) can be automatically sent to the electric vehicle as it moves. Thus, the list of available services corresponding to different electricity supply terminals can be continuously provided to the electrical vehicle. In other embodiments, if the electric vehicle has identified an electricity supply terminal as a destination to route to, then the list of available services for that electricity supply terminal can be transmitted to the electric vehicle. This method is described with reference to FIG. 12.

In step S1202, the electric vehicle can receive one or more lists of available services for one or more electricity supply terminals. As noted above, the lists can be received for electricity supply terminals within a predetermined distance of the electric vehicle, or they can correspond to a destination electricity supply terminal or one that is along a route which is being traveled by the electric vehicle.

In step S1204, the electric vehicle determines which services can be used by the electric vehicle. The electric vehicle will know which services that it can support.

In step S1206, the electric vehicle determines the intersection of the services that the electric vehicle can support and the services in the list of available services of candidate electricity supply terminals. In some embodiments, in addition to the different types of services described above, other services can relate to the application identifiers (AIDs) of the cards accepted by the electricity supply terminal, the AIDs of provisioned cards, the AIDs of cards stored on a connected phone, the AIDs aids of cards that can be accepted by any in-car NFC reader.

In step S1208, the electric vehicle then determines the candidate services from which the user of the electric vehicle can select. The user can then select a service from the list of candidate services (e.g., as in step S720 and S724 in FIG. 7 or in step S12 in FIG. 9).

Depending on the use case, a single payment service or method could be identified from the candidate payment methods list by automatically choosing a single payment method based or service on pre-established consumer preferences (e.g. preference could be “always use my Visa Debit card ending in 1234, if it is accepted”), or by presenting a choice to the user on the electric vehicle's infotainment system.

Note that the one or more of the steps illustrated in FIG. 12 can be performed before or after a user inserts a charging cable of an electricity supply terminal into their electric vehicle. One benefit to performing the method before inserting the charging cable into their electric car is that the user need not go back inside their car to make the selection of the service to use to obtain electricity from the electricity supply terminal.

Embodiments of the invention provide for a number of technical advantages. Using embodiments of the invention, energy supply terminals need not be retrofit with specialized hardware or software for a user to conveniently obtain energy from energy supply terminals for the user's vehicle. Further, in the context of electric car charging, the user can simply “plug and go” when charging an electric vehicle. In some embodiments, the user need not take active steps to pay for charging of the user's vehicle. Further, sensitive data such as payment credentials and payment tokens are protected as they are passed from the electric vehicle to a service provider computer. As such, the energy supply terminals (e.g., charging stations) need not be provided with special software and hardware to provide data security for the sensitive data. Still further, various services (e.g., for conducting payments) can be provided to the electric vehicle before the user charges their electric vehicle with electricity. These services can be matched with services compatible with those available to the electric vehicle, and only those services that are compatible with both the electric vehicle and the energy supply terminal will be presented to the user as options. The services can include payment methods that are performed using the charging cable or independent of the charging cable. This provides the user with a wide range of services to choose from, and improves the efficiency of the service selection process, since incompatible services are not presented to the user.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by an electric vehicle, a list of available services associated with an electricity supply terminal, the list of available services comprising one or more methods that do not transmit credentials or tokens via a charging cable and one or more methods that do transmit credentials or tokens via the charging cable;
determining, by the electric vehicle, a set of services in the list of available services, wherein the set of services includes services supported by the electric vehicle;
transmitting, by the electric vehicle to the electricity supply terminal, a service selection request comprising a service in the set of services; and
after transmitting the service selection request, receiving, by the electric vehicle from the electricity supply terminal via the charging cable, electricity.

2. The method of claim 1, wherein the service comprises a method that transmits a credential or token via the charging cable, and wherein the method further comprises:
obtaining the credential or the token;
generating an encrypted data packet including the credential or the token; and
providing the encrypted data packet to the electricity supply terminal via the charging cable, wherein the electricity supply terminal transmits the encrypted data packet to a service provider computer, which decrypts the encrypted data packet to obtain the credential or token and processes a transaction for supplying the electric vehicle with energy using the credential or the token.

3. The method of claim 2, wherein the electric vehicle is an electric car.

4. The method of claim 3, wherein the service provider computer processes the transaction by generating an authorization request message comprising the credential or token and a value associated with supplying the electricity to the electric vehicle.

5. The method of claim 2, wherein obtaining the credential or the token comprises:
retrieving the credential or the token from a memory in a user device that is separate from the electric vehicle.

6. The method of claim 1, wherein one or more methods that do not transmit credentials or tokens via the charging cable comprises interacting with a reader device on the electricity supply terminal to obtain the electricity or using an application on a user device to obtain the electricity.

7. The method of claim 1, wherein one or more methods that do transmit credentials or tokens via the charging cable comprises a method that transmits an account identifier via the charging cable.

8. The method of claim 1, wherein the electric vehicle is an electric car.

9. The method of claim 1, wherein the method further comprises:
transmitting, by the electric vehicle to the electricity supply terminal via the charging cable, a service detail request comprising indicators for the set of services; and
receiving, by the electric vehicle from the electricity supply terminal via the charging cable, a service detail response comprising electricity supply terminal data.

10. The method of claim 9, wherein the service detail response further comprises a mobility operator digital certificate and the electricity supply terminal data comprises a terminal identifier, and wherein the method further comprises:
validating, by the electric vehicle, that the mobility operator digital certificate is valid.

11. The method of claim 1, wherein the list of available services is received in a service discovery response from the electricity supply terminal, and wherein the method further comprises, before receiving the list of available services:
establishing a physical and electrical connection between the electric vehicle and the electricity supply terminal using the charging cable; and
transmitting, by the electric vehicle to the electricity supply terminal, a service discovery request.

12. The method of claim 1, wherein the list of available services associated with the electricity supply terminal is received by the electric vehicle from a remote computer, and wherein the electric vehicle determines the set of services in the list of available services by determining an intersection of the set of services associated with the electricity supply terminal and the services supported by the electric vehicle.

13. The method of claim 12, wherein the electric vehicle receives the list of available services over the air from the remote computer when the electricity supply terminal is within a predetermined distance of the electric vehicle.

14. An electric vehicle comprising:
a processor; and
a non-transitory computer readable medium, the non-transitory computer readable medium comprising code, executable by the processor, for performing operations comprising:
receiving a list of available services associated with an electricity supply terminal, the list of available services comprising one or more methods that do not transmit credentials or tokens via a charging cable and one or more methods that do transmit credentials or tokens via the charging cable;
determining a set of services in the list of available services, wherein the set of services includes services supported by the electric vehicle;
transmitting, to the electricity supply terminal, a service selection request comprising a service in the set of services; and
after transmitting the service selection request, receiving, from the electricity supply terminal via the charging cable, electricity.

15. The electric vehicle of claim 14, wherein the electric vehicle is an electric car.

16. The electric vehicle of claim 14, wherein the service comprises a method that transmits a credential or token via the charging cable, and wherein the operations further comprise:
obtaining the credential or the token;
generating an encrypted data packet including the credential or the token; and
providing the encrypted data packet to the electricity supply terminal via the charging cable, wherein the electricity supply terminal transmits the encrypted data packet to a service provider computer, which decrypts the encrypted data packet to obtain the credential or token and processes a transaction for supplying the electric vehicle with energy using the credential or the token.

17. A method comprising:
receiving, by an electricity supply terminal, a service selection request comprising a service in a set of services, after an electric an electric vehicle is provided with a list of available services associated with the electricity supply terminal, the list of available services comprising one or more methods that do not transmit credentials or tokens via a charging cable and one or more methods that do transmit credentials or tokens via the charging cable, wherein the electric vehicle determines the set of services in the list of available services, wherein the set of services includes services supported by the electric vehicle; and
after receiving the service selection request, providing, by the electric vehicle from the electricity supply terminal via the charging cable, electricity.

18. The method of claim 17, further comprising:
before receiving the service selection request, providing, by the electricity supply terminal, the list of available services associated with the electricity supply terminal via the charging cable.

19. The method of claim 18, wherein the list of available services is provided to the electric vehicle in a service discovery response from the electricity supply terminal, and wherein the method further comprises:
establishing a physical and electrical connection between the electric vehicle and the electricity supply terminal using the charging cable attached to the electricity supply terminal; and
receiving, by the electricity supply terminal the electricity supply terminal, a service discovery request.

20. The method of claim 18, further comprising:
before receiving the service selection request, providing, by a remote computer to the electric vehicle, the list of available services associated with the electricity supply terminal.
